(19) United States
(12) Patent Application Publication
(10) Pub. No.: US 2005/0221871 A1
(43) Pub. Date: Oct. 6, 2005

(54) Circuit and method for saving power of a mobile communication terminal

(75) Inventor: Hyun Min Kim, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: PANTECH CO., LTD.

(21) Appl. No.: 11/024,061

(22) Filed: Dec. 28, 2004

(30) Foreign Application Priority Data
Mar. 30, 2004 (KR) 10-2004-0021630

(51) Int. Cl. H04B 7/00; H04Q 7/20; H04M 1/00; H04B 1/38

(52) U.S. Cl. 455/574; 455/572

(57) ABSTRACT

The present invention relates to a circuit and method for saving power of a mobile communication terminal to reduce electric power consumption during time slot for transmitting information, by temporarily turning off parts of the mobile communication terminal when the mobile communication terminal communicates with a base station. The circuit for saving power of a mobile communication terminal comprises: a first switching means, turned on by parts driving pulse of high level provided under control of a processor, for supplying electric power to parts of the mobile communication terminal; and a second switching means, turned on by transmission enabling pulse of high level provided during time slot for transmitting information, for making the first switching means disable to prevent the electric power from being supplied to the parts of the mobile communication terminal.

### CROSS-REFERENCE TO RELATED APPLICATIONS

The present application is claiming priority of Korean Patent Application No. 10-2004-0021630, filed on Mar. 30, 2004, the content of which is incorporated herein by reference.

### BACKGROUND OF THE INVENTION

1. Field of the Invention

The present invention relates to a circuit and method for saving power of a mobile communication terminal. More particularly, the present invention relates to a circuit and method for saving a battery power of a mobile communication terminal during time slot for transmitting information. Further, the present invention relates to a mobile communication terminal equipped with a circuit for saving a battery power of the mobile communication terminal during time slot for transmitting information.

2. Description of the Related Art

Generally, a mobile communication terminal executes transmission of information for communication with a base station. The mobile communication terminal consumes a large amount of electric power when the mobile communication terminal transmits information to a base station. For instance, a Global System for Mobile communications (GSM) mobile communication terminal using Time Division Multiple Access (TDMA) system transmits information with electric power at every 4.615 ms (= 1/217 Hz). With conditions that maximum power is consumed in transmission and typical capacity of battery is 700 mA, an average current over 400 mA is used and an instant peak current of about 2.5 A is consumed in transmission of information.

On the other hand, in prior arts, parts of a mobile communication terminal such as a backlight for buttons, LCD backlights, a melody function part, a vibration motor, etc. are set to be turned on even when the mobile communication terminal consumes maximum power in transmitting information to a base station. For example, a backlight for buttons and LCD backlights are set to be turned on when a user opens a folder, receives a call or pushes buttons of the mobile communication terminal.

In a prior art, as illustrated in FIG. 1, although a mobile communication terminal consumes maximum power in transmitting information to a base station, a processor gives an order of turning on LCD backlights if the setting value is fitted (i.e. user opens a folder or receives a call). According to the order given by the processor, backlight driving signal (Backlight_EN) of high level is provided to turn on a transistor.

Therefore, the mobile communication terminal consumes electric power along with the parts of the mobile communication terminal while the mobile communication terminal consumes maximum power in transmitting information to a base station.

As described above, if both the mobile communication terminal and the parts consume electric power while the mobile communication terminal consumes maximum power in transmitting information to a base station, power consumption may exceed the capacity of battery. Thus, there is a problem in that the mobile communication terminal is suddenly turned off or reset, since the battery cannot supply required electric current.

### BRIEF SUMMARY OF THE INVENTION

The present invention intends to overcome the foregoing problems. It is an object of the present invention to provide a circuit and method for saving power of a mobile communication terminal to reduce electric power consumption during time slot for transmitting information. For such object, parts of the mobile communication terminal are temporarily turned off while the mobile communication terminal consumes maximum power in transmitting information to a base station.

Accordingly, there is provided a circuit for saving power of a mobile communication terminal comprising: a first switching means, turned on by parts driving pulse of high level provided under control of a processor, for supplying electric power to parts of the mobile communication terminal; and a second switching means, turned on by transmission enabling pulse of high level provided during time slot for transmitting information, for making the first switching means disable to prevent the electric power from being supplied to the parts of the mobile communication terminal.

Preferably, the first switching means and the second switching means may be transistors and a base terminal of the first switching means may be connected to a collector terminal of the second switching means.

Preferably, the parts of the mobile communication terminal may comprise a backlight for buttons, LCD backlights, a melody function part and a vibration motor.

Differently, there is provided a method for saving power of a mobile communication terminal comprising: driving parts of the mobile communication terminal by providing parts driving pulse of high level to the parts, if a set value needed for driving the parts is met; and if time slot for transmitting information comes, providing transmission enabling pulse of high level to change the parts driving pulse of high level into low level and thus blocking electric power which has been supplied to the parts.

Differently, there is provided a mobile communication terminal equipped with a circuit for saving power of the mobile communication terminal, wherein the circuit comprises: a first switching means, turned on by parts driving pulse of high level provided under control of a processor, for supplying electric power to parts of the mobile communication terminal; and a second switching means, turned on by transmission enabling pulse of high level provided during time slot for transmitting information, for making the first switching means disable to prevent the electric power from being supplied to the parts of the mobile communication terminal.

Preferably, the first switching means and the second switching means may be transistors and a base terminal of the first switching means may be connected to a collector terminal of the second switching means.

Preferably, the parts of the mobile communication terminal may comprise a backlight for buttons, LCD backlights, a melody function part and a vibration motor.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates an exemplary configuration of a driving circuit for backlight in a conventional mobile communication terminal;

FIG. 2 illustrates configuration of a circuit for saving power of a mobile communication terminal, according to an exemplary embodiment of the present invention;

FIG. 3 is a flowchart illustrating a method for saving power of a mobile communication terminal, according to an exemplary embodiment of the present invention; and

FIG. 4 illustrates exemplary waveforms of a transmission enabling pulse and a parts driving pulse, according to the present invention.

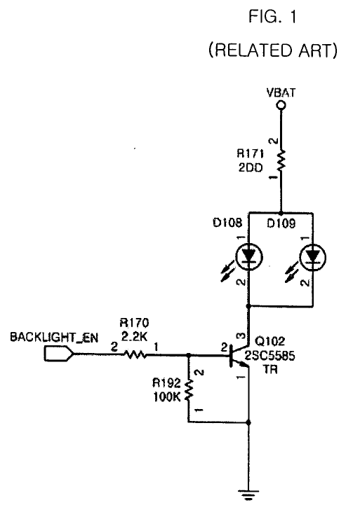

### DETAILED DESCRIPTION OF THE PREFERRED EMBODIMENTS

Hereinafter, a circuit and method for saving power of a mobile communication terminal according to an exemplary embodiment of the present invention will be described in detail with reference to the attached drawings.

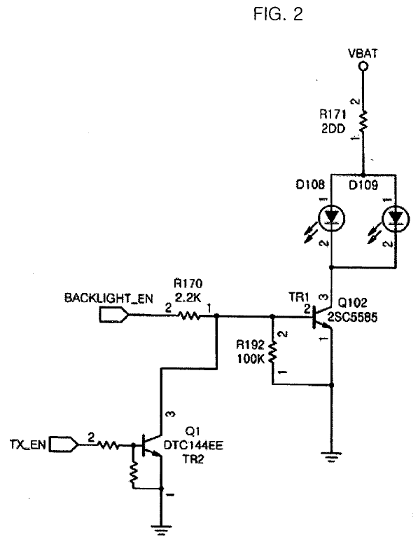

FIG. 2 illustrates configuration of a circuit for saving power of a mobile communication terminal according to an exemplary embodiment of the present invention. An LCD backlight will be described herein as an example among parts such as a backlight for buttons, LCD backlights, a melody function part, a vibrating motor and so on.

A first transistor (TR1) is turned on by backlight driving pulse (Backlight_EN) of high level provided under control of a controller (processor), thereby turning on the LCD backlight.

If the LCD backlight is set to be turned on when a user opens a folder, receives a call or presses a button of mobile communication terminal, the processor provides the backlight driving pulse of high level to the first transistor (TR1) when the set events (i.e. opening a folder, receiving a call or pressing a button) occur.

On the other hand, a second transistor (TR2), whose collector terminal is connected to a base terminal of the first transistor (TR1), is turned on by transmission enabling pulse (TX_EN) of high level provided under control of the processor, thereby changing the transmission enabling pulse of high level into low level forcibly.

The processor outputs transmission enabling pulse of high level to the second transistor (TR2) during time slot for transmitting information (e.g. for 0.576 ms at every 4.615 ms (= 1/217 Hz) in a GSM mobile communication terminal).

As described above, if the backlight driving pulse inputted to the first transistor (TR1) is converted to be low level by the second transistor (TR2) turned on by the transmission enabling pulse of high level, the first transistor (TR1) is turned off and turns off the LCD backlight.

Here, when the backlight driving pulse is forcibly changed to be low level by the second transistor (TR2) turned on by the transmission enabling pulse, resistors of appropriate values are needed in series not to load a General Purpose Input/Output (GPIO) pin.

At this time, it should be noted that the present invention relates to a mobile communication terminal equipped with the circuit illustrated in FIG. 2 as well.

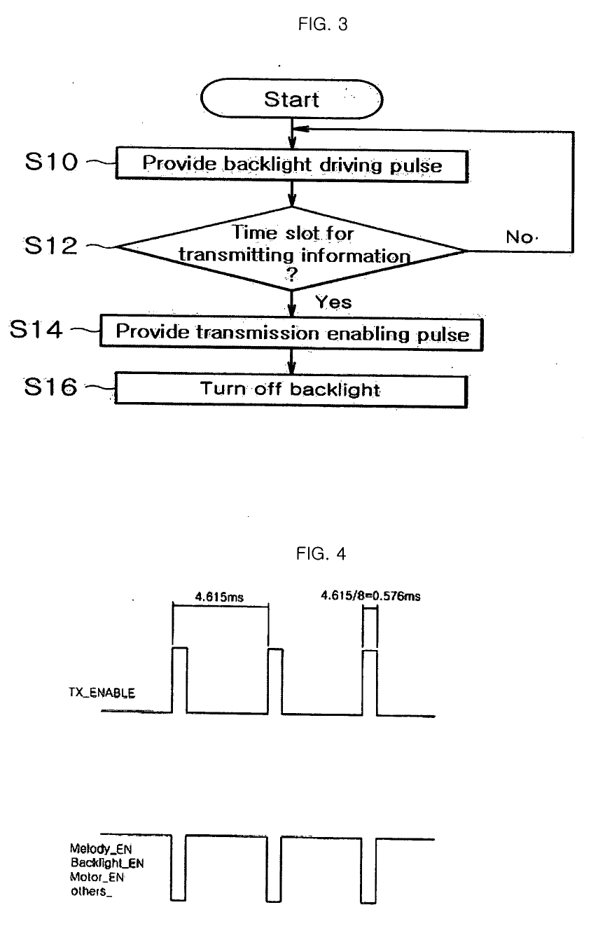

FIG. 3 is a flow chart illustrating a method for saving power of a mobile communication terminal according to an exemplary embodiment of the present invention. An LCD backlight will be described herein as an example among parts such as a backlight for buttons, LCD backlights, a melody function part, a vibrating motor and so on.

It is assumed that the LCD backlight is set to be turned on when a user opens a folder, receives a-call or presses a button of mobile communication terminal.

A first transistor (TR1) is turned on by backlight driving pulse (Backlight_EN) of high level provided under control of a processor, when the set events (e.g. opening a folder, receiving a call or pressing a button) occur (S10). Then, the first transistor (TR1) turns on the LCD backlight.

As described above, when time slot for transmitting information comes while the LCD backlight is turned on by the enabled first transistor (TR1) (S12), a processor provides transmission enabling pulse to a second transistor (TR2), thereby turning on the second transistor (TR2) (S14).

If the second transistor (TR2) is turned on through the step S14, the backlight driving pulse of high level inputted to the base terminal of the first transistor (TR1) is converted to a low level pulse by the collector terminal of the second transistor (TR2) connected to the base terminal of the first transistor (TR1).

Therefore, the first transistor (TR1) is turned off while the second transistor (TR2) is turned on (during time slot for transmitting information), thereby turning off the LCD backlight (S16).

As described above, parts such as a backlight for buttons, LCD backlights, a melody function unit, a vibrating motor and so on are turned off during every time slot for transmitting information (e.g. for 0.576 ms), according to the present invention. Since the period and duration time are very short, a user cannot recognize any differences.

For instance, a GSM mobile communication terminal transmits information to a base station for 0.576 ms at every 4.615 ms. As shown in FIG. 4, transmission enabling pulse of high level is transmitted out for a fixed time (0.576 ms) with a period (4.615 ms). During the time the transmission enabling pulse of high level is outputted, a parts driving pulse is changed into a low level. Thereby, the parts such as a backlight for buttons, LCD backlights, a melody function part, a vibrating motor, etc. are turned off.

A method and circuit for saving power of mobile communication terminal, and a mobile communication terminal equipped with a circuit for saving power thereof according to the present invention is not limited to the foregoing preferred embodiments. And various alterations and modifications will no doubt become apparent to those skilled in the art within the true spirit and scope of the invention.

Thus, the following advantageous effects can be obtained through a circuit and method for saving power of a mobile communication terminal, and a mobile communication terminal equipped with a circuit for saving power thereof according to the present invention.

It is possible to reduce electric power consumption, a peak current and an overall average current during transmission period, by temporarily turning off the parts of the mobile communication terminal when the mobile communication terminal consumes maximum power in transmitting information to a base station.

Moreover, the present invention is more effective for a mobile communication terminal using TDMA method, whose transmission power is high and transmission period is constant.

1. A circuit for saving power of a mobile communication terminal comprising:
a first switching means, turned on by parts driving pulse of high level provided under control of a processor, for supplying electric power to parts of the mobile communication terminal; and
a second switching means, turned on by transmission enabling pulse of high level provided during time slot for transmitting information, for making the first switching means disable to prevent the electric power from being supplied to the parts of the mobile communication terminal.

2. The circuit of claim 1, wherein the first switching means and the second switching means are transistors and a base terminal of the first switching means is connected to a collector terminal of the second switching means.

3. The circuit of claim 1, wherein the parts of the mobile communication terminal comprises a backlight for buttons, LCD backlights, a melody function part and a vibration motor.

4. A method for saving power of a mobile communication terminal comprising:
driving parts of the mobile communication terminal by providing parts driving pulse of high level to the parts, if a set value needed for driving the parts is met; and
if time slot for transmitting information comes, providing transmission enabling pulse of high level to change the parts driving pulse of high level into low level and thus blocking electric power which has been supplied to the parts.

5. A mobile communication terminal equipped with a circuit for saving power of the mobile communication terminal, wherein the circuit comprises:
a first switching means, turned on by parts driving pulse of high level provided under control of a processor, for supplying electric power to parts of the mobile communication terminal; and
a second switching means, turned on by transmission enabling pulse of high level provided during time slot for transmitting information, for making the first switching means disable to prevent the electric power from being supplied to the parts of the mobile communication terminal.

6. The mobile communication terminal of claim 5, wherein the first switching means and the second switching means are transistors and a base terminal of the first switching means is connected to a collector terminal of the second switching means.

7. The mobile communication terminal of claim 5, wherein the parts of the mobile communication terminal comprises a backlight for buttons, LCD backlights, a melody function part and a vibration motor.
